(19) United States
(12) Patent Application Publication
(10) Pub. No.: US 2012/0163812 A1
(43) Pub. Date: Jun. 28, 2012

(54) METHOD AND APPARATUS FOR TRANSMITTING PACKET DATA OVER OPTICAL TRANSPORT NETWORK

(75) Inventors: Ji Wook YOUN, Daejeon (KR); Jong Yoon Shin, Daejeon (KR)

(73) Assignee: Electronics and Telecommunications Research Institute, Daejeon (KR)

(21) Appl. No.: 13/334,044

(22) Filed: Dec. 21, 2011

(30) Foreign Application Priority Data
Dec. 22, 2010 (KR) 10-2010-0132856

(51) Int. Cl. H04J 14/00

(52) U.S. Cl. 398/45

(57) ABSTRACT

A packet transmitting method and apparatus in an optical transport network may be provided. The packet transmitting method may include sensing a request for transmitting a packet client signal of a predetermined capacity, during transmission operated based on an ODUflex(GFP) scheme, extending, to the predetermined capacity, a size of a connection link among a transmitting apparatus, a relay apparatus, and a receiving apparatus when the request is sensed, expanding, to the predetermined capacity, a bandwidth among the transmitting apparatus, the relay apparatus, and the receiving apparatus when the size of the connection link is extended, and transmitting the packet client signal by changing a transmission scheme from the ODUflex(GFP) scheme to an ODUk(GFP) scheme, when the bandwidth is expanded.

### CROSS-REFERENCE TO RELATED APPLICATION

This application claims the benefit of Korean Patent Application No. 10-2010-0132856, filed on Dec. 22, 2010, in the Korean Intellectual Property Office, the disclosure of which is incorporated herein by reference.

### BACKGROUND

1. Field of the Invention

The present invention relates to a method and apparatus for dynamically transmitting a packet client signal over an optical transport network, and more particularly, to a dynamic hitless packet transmitting method and apparatus that may increase and decrease an amount of packet transmission without packet loss in an optical transport network.

2. Description of the Related Art

An optical transport network may define a transmission signal, for example, an optical channel payload unit k (OPUk), a flexible optical channel payload unit (OPUflex), an optical channel data unit k (ODUk), a flexible optical channel data unit (ODUflex), an optical channel transport unit k (OTUk). In this example, k=1, 2, 3, and 4. The ODUflex may be defined to flexibly and effectively receive a client signal, particularly, a packet signal, with an advanced transmission efficiency. An ODUflex(GFP) is obtained by encapsulating a packet signal based on a generic framing procedure (GFP), GFP-mapping the encapsulated packet signal to an ODUflex payload, and adding an ODUflex overhead.

The ODUflex(GFP) may be multiplexed by a generic mapping procedure (GMP) in a higher order ODUk (HO ODU k) having a higher order than the ODUflex(GFP). In this example, k=2, 3, and 4.

When a 10 GBASE-R packet client signal is adopted by an HO ODU2 using the ODUflex(GFP) according to the conventional method, packet loss may occur in a case where an average frame size of a packet client signal is greater than a predetermined byte. That is, when the 10 GBASE-R packet client signal is adopted using the ODUflex(GFP) n=8, transmitting a packet client signal without a loss may be difficult depending on a size of a frame of a packet client signal. Therefore, when the conventional method changes a size of the ODUflex(GFP) dynamically, to adopt a packet client signal effectively in the optical transport network, a transmission speed of the packet client signal may not be guaranteed thoroughly in a case where a size of a frame of the packet client signal is greater than a predetermined byte although a size of the ODUflex(GFP) is changed with hitless. In this example, a packet client signal may be delayed or discarded.

### SUMMARY

An aspect of the present invention provides a packet transmitting method and apparatus in an optical transport network.

Another aspect of the present invention also provides a dynamic packet transmitting method and apparatus that may enable a hitless increase and decrease in an amount of packet transmission without packet loss, irrespective of a size of a packet frame, when a packet client signal is adopted by an ODUflex(GFP) in an optical transport network.

According to an aspect of the present invention, there is provided a transmitting apparatus in an optical transport network, when a request for transmitting a packet client signal of a predetermined capacity is sensed, the apparatus including a client access unit to selectively output a packet client signal to an ODUk mapping unit or to an ODUflex mapping unit, based on a control overhead, the ODUk mapping unit to perform mapping of the packet client signal to an ODUk signal, to insert an ODUk overhead to the ODUk signal, and to output the ODUk signal, the ODUflex mapping unit to perform mapping of the packet client signal to an ODUflex signal, to insert an ODUflex overhead to the ODUflex signal, and to output the ODUflex signal, an ODUflex multiplexing unit to receive a plurality of ODUflex signals from the ODUflex mapping unit, to multiplex the ODUflex signals, and to output the multiplexed ODUflex signal, and an OTUk mapping unit to perform mapping of the ODUk signal output from the ODUk mapping unit to an OTUk signal, to insert an OTUk overhead to the OTUk signal, and to output the OTUk signal, or to perform mapping of the multiplexed ODUflex signal output from the ODUflex multiplexing unit to an OTUk signal, to insert an OTUk overhead to the OTUk signal, and to output the OTUk signal.

According to another aspect of the present invention, there is provided a relay apparatus in an optical transport network, the apparatus including an OTUk mapping unit to perform de-mapping of an OTUk signal received from a transmitting apparatus so as to extract an ODUk signal, to determine a control overhead included in the ODUk signal so as to determine a mapping scheme associated with the ODUk signal, to output the ODUk signal to an ODU switching unit when the mapping scheme is an ODUk(GFP) scheme, and to output the ODUk signal to an ODUflex multiplexing unit when the mapping scheme is an ODUflex(GFP) scheme, the ODUflex multiplexing unit to de-multiplex the ODUk signal inputted by the OTUk mapping unit, and to output a plurality of ODUflex signals, and an ODU switching unit to perform a switching function with respect to the ODUk signal received from the OTUk mapping unit or the ODUflex signals received from the ODUflex multiplexing unit, based on overhead information associated with a corresponding signal.

According to still another aspect of the present invention, there is provided a receiving apparatus in an optical transport network, the apparatus including an OTUk mapping unit to perform de-mapping of a received OTUk signal so as to extract an ODUk signal, to determine a control overhead included in the ODUk signal so as to determine a mapping scheme associated with the ODUk signal, to output the ODUk signal to an ODUk mapping unit when the mapping scheme is an ODUk(GFP) scheme, and to output the ODUk signal to an ODUlex multiplexing unit when the mapping scheme is an ODUflex(GFP) scheme, the ODUflex multiplexing unit to de-multiplex the ODUk signal inputted by the OTUk mapping unit, and to output a plurality of ODUflex signals, the ODUflex mapping unit to perform de-mapping of the ODUflex signals output by the ODUflex multiplexing unit so as to extract a packet client signal, the ODUk mapping unit to perform de-mapping of the ODUk signal input by the OTUk mapping unit so as to extract a packet client signal, and a client access unit to selectively receive the packet client signal from the ODUk mapping unit or the ODUflex mapping unit, based on the control overhead.

According to yet another aspect of the present invention, there is provided a method of transmitting a packet in an optical transport network, the method including sensing a request for increasing a capacity of a signal transmitted and received among a transmitting apparatus, a relay apparatus, and a receiving apparatus, during transmission operated based on an ODUkfles(GFP) scheme, determining a tributary slot (TS) to be added to increase, in response to a request, a size of a connection link among the transmitting apparatus, the relay apparatus, and the receiving apparatus when the request is sensed, increasing a bandwidth corresponding to the TS to be added when the TS to be added is determined, increasing the size of the connection link among the transmitting apparatus, the relay apparatus, and the receiving apparatus when the bandwidth is increased, and transmitting a packet client signal by changing a transmission scheme from the ODUkflex(GFP) scheme to an ODUk(GFP) scheme when the size of the connection link is increased.

According to further another aspect of the present invention, there is provided a method of transmitting a packet in an optical transport network, the method including sensing a request for transmitting a packet client signal of a predetermined capacity, during transmission operated based on an ODUflex(GFP) scheme, extending, to the predetermined capacity, a size of a connection link among a transmitting apparatus, a relay apparatus, and a receiving apparatus when the request is sensed, expanding, to the predetermined capacity, a bandwidth among the transmitting apparatus, the relay apparatus, and the receiving apparatus when the size of the connection link is extended, and transmitting the packet client signal by changing a transmission scheme from the ODUflex(GFP) scheme to an ODUk(GFP) scheme, when the bandwidth is expanded.

According to still another aspect of the present invention, there is provided a method of transmitting a packet in an optical transport network, the method including sensing a request for decreasing a capacity of a signal transmitted and received among a transmitting apparatus, a relay apparatus, and a receiving apparatus, during transmission operated based on an ODUk(GFP) scheme, determining a tributary slot (TS) to be removed to decrease, in response to a request, a size of a connection link among the transmitting apparatus, the relay apparatus, and the receiving apparatus when the request is sensed, decreasing a bandwidth corresponding to the TS to be removed when the TS to be removed is determined, decreasing the size of the connection link among the transmitting apparatus, the relay apparatus, and the receiving apparatus by removing the TS to be removed when the bandwidth is decreased, and transmitting a packet client signal by changing a transmission scheme from the ODUk(GFP) scheme to an ODUflex(GFP) scheme when the size of the connection link is decreased.

Additional aspects, features, and/or advantages of the invention will be set forth in part in the description which follows and, in part, will be apparent from the description, or may be learned by practice of the invention.

### EFFECT

Exemplary embodiments may provide a dynamic packet transmission method that enables a hitless increase and decrease in an amount of packet transmission without packet loss in an optical transport network. When a 10 GBASE-R signal is transmitted based on an ODUflex(GFP) scheme, the transmission may be performed by changing a transmission scheme from the ODUflex(GFP) scheme to an LO ODU2(GFP) scheme using a control overhead including a bandwidth over resizing (BWOR) bit corresponding to information indicating a change in a bandwidth and a link connection over resizing (LCOR) bit corresponding to information indicating a change in a size of a connection link. Exemplary embodiments may prevent packet loss occurring in a frame that is greater than a number of predetermined bytes when the 10 GBASE-R signal is transmitted based on the ODUflex(GFP).

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a configuration of a transmitting apparatus in an optical transport network according to an embodiment of the present invention;

FIG. 2 is a diagram illustrating a structure of a control overhead to be inserted to an OPUk overhead according to an embodiment of the present invention;

FIG. 3 is a diagram illustrating a configuration of a relay apparatus in an optical transport network according to an embodiment of the present invention;

FIG. 4 is a diagram illustrating a configuration of a receiving apparatus in an optical transport network according to an embodiment of the present invention;

FIG. 5 is a diagram illustrating a configuration of an optical transport network according to an embodiment of the present invention;

FIG. 6 is a flowchart illustrating a transmission process performed when a capacity of a packet client signal increases to be equivalent to a predetermined capacity in an optical transport network according to an embodiment of the present invention;

FIGS. 7 through 9 are diagrams illustrating a flow of a message when a capacity of a packet client signal increases to be equivalent to a predetermined capacity in an optical transport network according to an embodiment of the present invention;

FIG. 10 is a flowchart illustrating a transmission process performed when a capacity of a packet client signal decreases to be less than a predetermined capacity in an optical transport network according to an embodiment of the present invention; and

FIGS. 11 through 15 are diagrams illustrating a flow of a transmission message when a capacity of a packet client signal decreases to be less than a predetermined capacity in an optical transport network according to an embodiment of the present invention.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

Exemplary embodiments may provide a dynamic packet transmission method and apparatus that may enable a hitless increase and decrease in an amount of packet transmission without packet loss when a packet client signal is adopted using the ODUflex(GFP).

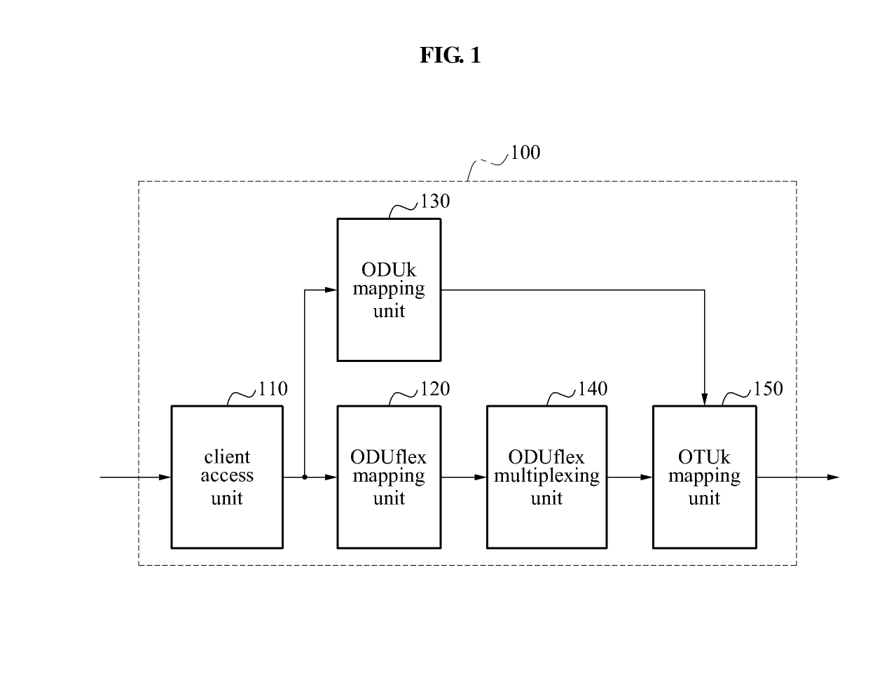

FIG. 1 illustrates a configuration of a transmitting apparatus 100 in an optical transport network according to an embodiment of the present invention.

Referring to FIG. 1, the transmitting apparatus 100 in the optical transport network may include a client access unit 110, an ODUflex mapping unit 120, an ODUk mapping unit 130, an ODUflex multiplexing unit 140, and an OTUk mapping unit 150.

When a request for transmitting a packet client signal of a predetermined capacity is sensed from a network management system (NMS), the client access unit 110 may output a packet client signal to the ODUk mapping unit 130. When the request is not sensed, the client access unit 110 may output a packet client signal to the ODUflex mapping unit 120. In this example, the predetermined capacity may be a maximal transmission capacity of 10 GBASE-R, that is, 10 gigabytes/second (Gb/s).

The ODUk mapping unit 130 may encapsulate the packet client signal, may perform mapping of the encapsulated packet client signal to an ODUk signal based on a generic framing procedure (GFP), may insert an ODUk overhead to the ODUk signal, and may output the ODUk signal.

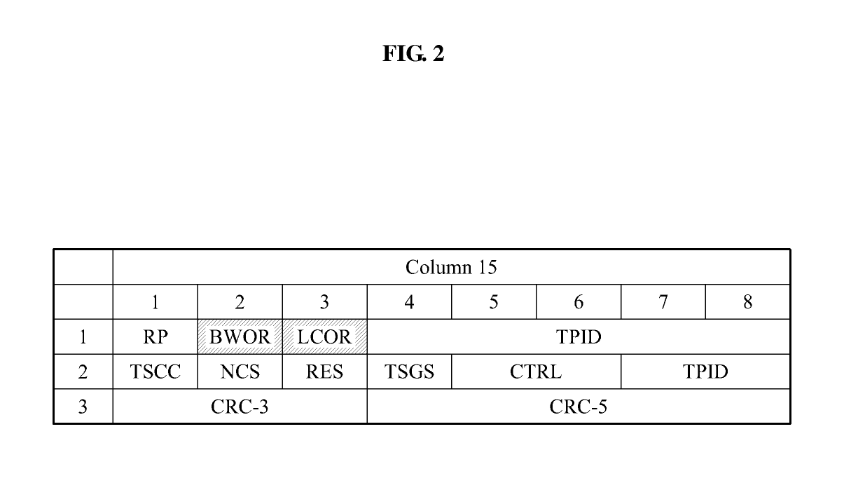

When an OPUk overhead or an OPUkflex overhead is inserted, the client access unit 110 may insert a control overhead including information associated with a mapping scheme, a bandwidth over resizing (BWOR) bit corresponding to information indicating a change in a bandwidth, and a link connection over resizing (LCOR) bit corresponding to information indicating a change in a size of a connection link. Here, the mapping scheme may include an ODUk(GFP) scheme or an ODUflex(GFP) scheme. The BWOR bit and the LCOR bit will be described with reference to FIG. 2.

The ODUflex mapping unit 120 may encapsulate the packet client signal based on the GFP, may perform mapping of the encapsulated packet client signal to an ODUflex signal, may insert an ODUflex overhead to the ODUflex signal, and may output the ODUflex signal.

The ODUflex multiplexing unit 140 may receive a plurality of ODUflex signals from the ODUflex mapping unit 120, and may output a multiplexed ODUflex signal.

The OTUk mapping unit 150 may perform mapping of the ODUk signal input by the ODUk mapping unit 130 to an OTUk signal, may insert an OTUk overhead to the OTUk signal, and may output the OTUk signal. Also, the OTUk mapping unit 150 may perform mapping of the multiplexed ODUflex signal output from the ODUflex multiplexing unit 140 to an OTUk signal, and may inset an OTUk overhead to the multiplexed ODUflex signal.

Referring to FIG. 1, the client access unit 110 may output a packet client signal, selectively, to the ODUflex mapping unit 120 or the ODUk mapping unit 130. Also, the OTUk mapping unit 150 may receive a signal, selectively, from the ODUk mapping unit 130 or the ODUflex multiplexing unit 140. Accordingly, the client access unit 110 and the OTUk mapping unit 150 may need a control signal for outputting and receiving a signal selectively.

FIG. 2 illustrates a structure of a control overhead to be inserted to an OPUk overhead region according to an embodiment of the present invention.

Referring to FIG. 2, the control overhead may be divided into two parts for a bandwidth resizing protocol operation and a link connection resizing protocol operation. Here, the part to be used for the bandwidth resizing protocol operation may include a tributary slot connectivity check (TSCC) signal, a network connectivity status (NCS) signal, and a bandwidth over resizing (BWOR) signal. The part to be used for the link connection resizing protocol operation may include a tributary port ID (TPID) signal, a tributary slot group status (TSGS) signal, a control (CTRL) signal, and a link connection over resizing (LCOR) signal.

The control overhead may use three bytes in a first row through a third row of a fifteenth column of an OPUk frame. Among signals of the control overhead of FIG. 2, only an NCS signal may be inserted to the OPUflex overhead, and remaining signals may be inserted to the OPUk overhead and transmitted. Hereinafter, the signals in the control overhead will be described. An RP signal indicates using the three bytes in the first row through the three row of the fifteenth column of the OPUk frame as an ODU flex hitless resizing protocol control overhead or an ODUk(GFP) hitless resizing protocol control overhead. When an RP value is zero, the RP signal indicates that the three bytes are to be used as an OPUk overhead, and when the RP value is 1, the RP signal indicates that the three bytes are to be used as the ODUflex(GFP) hitless resizing protocol control overhead or the ODUk(GFP) hitless resizing protocol control overhead. The TSCC signal may be a signal bit that checks a connectivity of a tributary slot (TS), and may be located between an ODUflex source and a sink, and may be transmitted. The NCS signal may denote a network connection state. The TPID signal may denote a port value of TSs. The TSGS signal denotes a status of a TS group. The CTRL signal may be a control signal, and may have a value of “01” when the client access unit 110 adds a TS and may have a value of “10” when the client access unit 110 removes the TS. In addition, the control signal may have a value of “11” when the client access unit 110 is in a normal state, and the control signal may have a value of “00” when the client access unit 110 is idle state.

The control overhead may use the control signal for a conventional ODUflex(GFP) hitless resizing protocol as is, and may additionally define two signals. The newly added signals are a BWOR signal and an LCOR signal, and each signal is formed of one bit and uses a bit that is not used in a conventional scheme. The newly added BWOR signal is utilized along with the conventional bandwidth resizing protocol, and the LCOR signal is utilized along with the conventional link connection resizing protocol. Here, the BWOR signal may be information indicating a change in a bandwidth, and the LCOR signal may be information indicating a change in a size of a connection link.

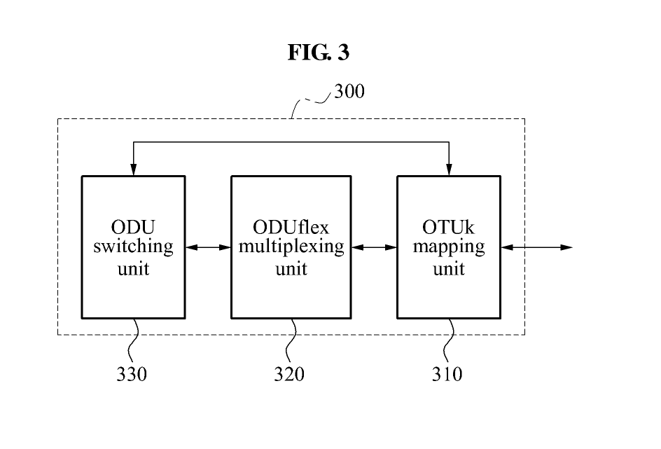

FIG. 3 illustrates a configuration of a relay apparatus 300 in an optical transport network according to an embodiment of the present invention.

Referring to FIG. 3, the relay apparatus 300 in the optical transport network may include an OTUk mapping unit 310, an ODUflex multiplexing unit 320, and an ODU switching unit 330.

The OTUk mapping unit 310 may perform de-mapping of an OTUk signal received from a transmitting apparatus so as to extract an ODUk signal, may determine a control overhead included in the ODUk signal so as to determine a mapping scheme associated with the ODUk signal, may output the ODUk signal to the ODU switching unit 330 when the mapping scheme is the ODUk(GFP) scheme, and may output the ODUk signal to the ODUflex multiplexing unit 320 when the mapping scheme is an ODUflex(GFP) scheme.

The ODUflex multiplexing unit 320 may perform de-multiplexing of the ODUk signal input by the OTUk mapping unit 310, and may output a plurality of ODUflex signals.

The ODU switching unit 330 may perform a switching function with respect to the ODUk signal received from the OTUk mapping unit 310 or may perform a switching function with respect to the ODUflex signals received from the ODUflex multiplexing unit 320, based on overhead information associated with a corresponding signal.

When the ODUflex multiplexing unit 320 receives the plurality of ODUflex signals from the ODU switching unit 330 based on switching of the ODU switching unit 330, the ODUflex multiplexing unit 320 may multiplex the received ODUflex signals, and may output the multiplexed signal to the OTUk mapping unit 310.

When the OTUk mapping unit 310 receives the ODUk signal from the ODU switching unit 330 based on the switching of the ODU switching unit 330, the OTUk mapping unit 310 may perform mapping of the ODUk signal to an OTUk signal, may insert an OTUk overhead to the OTUk signal, and may output the OTUk signal. Also, when the OTUk mapping unit 310 receives the multiplexed signal from the ODUflex multiplexing unit 320, the OTUk mapping unit 310 may perform mapping of the multiplexed signal to the OTUk signal, may insert an OTUk overhead to the OTUk signal, and may output the OTUk signal.

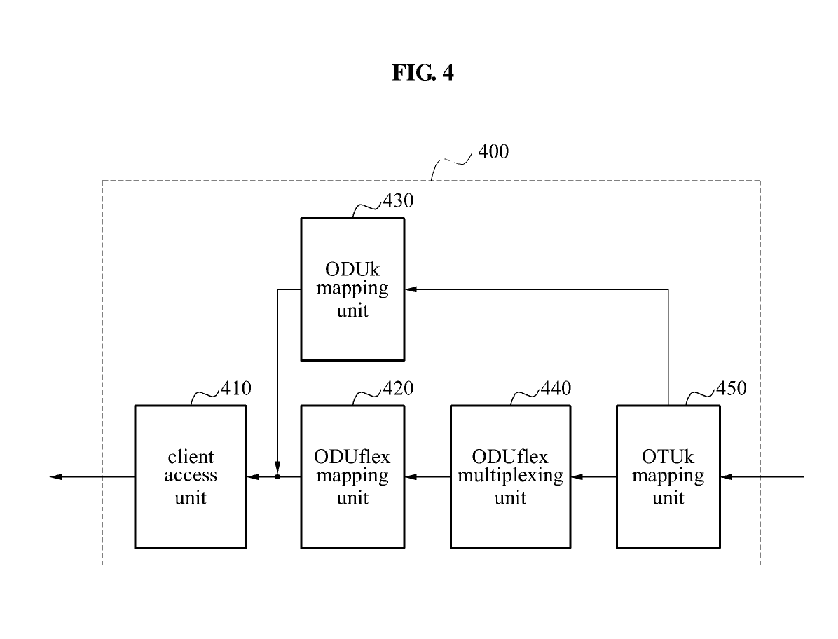

FIG. 4 illustrates a configuration of a receiving apparatus 400 in an optical transport network according to an embodiment of the present invention.

Referring to FIG. 4, the receiving apparatus 400 in the optical transport network may include a client access unit 410, an ODUflex mapping unit 420, an ODUk mapping unit 430, an ODUflex multiplexing unit 440, and an OTUk mapping unit 450.

Here, when the OTUk mapping unit 450 receives an OTUk signal, the OTUk mapping unit 450 may perform de-mapping of the OTUk signal so as to extract an ODUk signal, may determine a control overhead included in the ODUk signal so as to determine a mapping scheme associated with the ODUk signal, may output the ODUk signal to the ODUk mapping unit 430 when the mapping scheme is an ODUk(GFP) scheme, and may output the ODUk signal to the ODUflex multiplexing unit 440 when the mapping scheme is an ODUflex(GFP) scheme.

In this example, the control overhead may include information associated with a mapping scheme, a BWOR bit corresponding to information indicating a change in a bandwidth, and an LCOR bit corresponding to information indicating a change in a size of a connection link.

The ODUflex multiplexing unit 440 may perform de-multiplexing of the ODUk signal input from the OTUk mapping unit 450, and output a plurality of ODUflex signals.

The ODUflex mapping unit 420 may perform de-mapping of the ODUflex signals input from the ODUflex multiplexing unit 440 so as to extract a packet client signal.

The ODUk mapping unit 430 may perform de-mapping of the ODUk signal input from the OTUk mapping unit 450 so as to extract a packet client signal.

The client access unit 410 may output the packet client signal received from the ODUk mapping unit 430 or the ODUflex mapping unit 420.

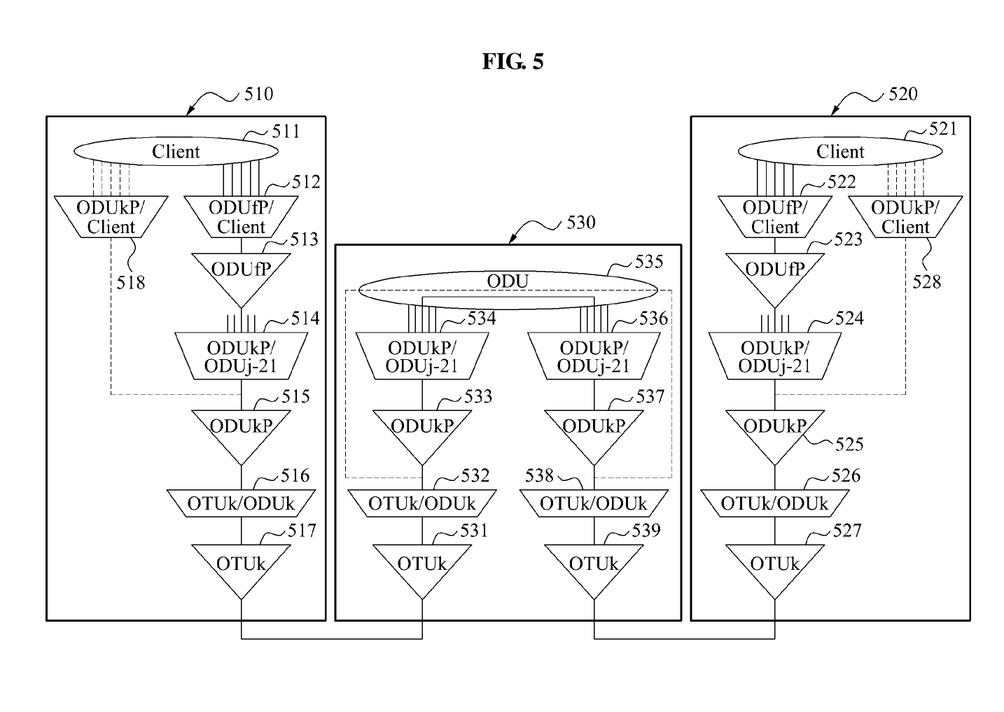

FIG. 5 illustrates a configuration of an optical transport network according to an embodiment of the present invention.

Referring to FIG. 5, a client signal transmitting method in the optical transport network based on a conventional ODUflex(GFP) hitless resizing protocol is drawn by a straight line.

A client signal transmitting method in the optical transport network based on a ODUk(GFP) hitless resizing protocol proposed by the exemplary embodiments is drawn by a dotted line.

The optical transport network may include transceiving apparatuses 510 and 520 capable of performing transmission and reception, and a relay apparatus 530.

Hereinafter, there may be provided comparisons between the conventional method and the method of the exemplary embodiment in a case where a request for transmitting a packet client signal of 10 Gb/s is sensed while a packet client signal of about 7.5 Gb/s is being transferred using an ODUflex(GFP) signal having six TSs.

According to the conventional method, a conventional transceiving apparatus, for example, the transceiving apparatuses 510 and 520, may include a client block that provides a matching function for a packet client signal, for example, client blocks 511 and 521, an ODUfP/Client block that performs mapping of the packet client signal to an ODUflex signal, for example, ODUfP/Client blocks 512 and 522, an ODUfP block that inserts an ODUflex overhead, for example, ODUfP blocks 513 and 523, an ODUkP/ODUj-21 block that performs mapping of a plurality of ODUflex signals to an ODUk signal, for example, ODUkP/ODUj-21 blocks 514 and 524, an ODUkP block that inserts an ODUk overhead, for example, ODUkP blocks 515 and 525, and an OTUk/ODUk block that performs mapping of the ODUk signal to an OTUk signal, for example, OTUk/ODUk blocks 516 and 526, and an OTUk block that inserts an OTUk overhead, for example, OTUk blocks 517 and 527.

Conversely, according to the exemplary embodiment, a transceiving apparatus, for example, the transceiving apparatuses 510 and 520, may further include an ODUkP/Client block that performs mapping of the packet client signal to the ODUk signal, for example, ODUkP/Client blocks 518 and 528.

According to the conventional method, a packet client signal of 7.5 Gb/s is GFP-mapped to an ODUflex signal in the ODUfP/Client block, and an ODUflex overhead may be inserted to the ODUflex signal in the ODUfP block. The ODUflex signal may be GMP-mapped to an ODUk signal (k=2) having six TSs, in the ODUkP/ODUj-21 block, and an ODUk overhead may be inserted to the ODUk signal, in the ODUkP block. Subsequently, the ODUk signal may be mapped to an OTUk signal (k=2), in the OTUk/ODUk block, an OTUk overhead may be inserted to the OTUk signal, in the OTUk block, and the OTUk signal may be transmitted to the optical transport network. In this example, when an instruction to increase a capacity of the packet client signal to 10 Gb/s is received from an NMS, a number of TSs of the ODUk signal may need to be increased to eight from six, and a capacity of the ODUflex signal may be increased to 10 Gb/s in the ODUfP/Client block. Subsequently, a packet client signal of 10 Gb/s is received, and may be transmitted to the optical transport network after performing the process described in the foregoing.

According to the exemplary embodiments, when a packet client signal of 7.5 Gb/s is input, the packet client signal is transferred using an ODUflex(GFP) having six TSs, in the same manner as the conventional method.

In this example, an instruction to increase a capacity of the packet client signal to 10 Gb/s is received from the NMS, a number of TSs of an ODUk signal may not be increased. The packet client signal may be transmitted to the ODUkP/Client block, in the client block. The client signal of 10 Gb/s may be GFP-mapped to an ODUk signal (k=2), directly, without being mapped to an ODUflex signal, and an ODUk overhead may be inserted to the ODUk signal in the ODUkP block. Subsequently, the ODUk signal may be mapped to an OTUk signal (k=2) in the OTUk/ODUk block, and an OTUk overhead may be inserted to the OTUk signal in the OTUk block, and the OTUk signal may be transferred to the optical transport network. That is, the client block may change a mapping scheme so as to enable a GFP encapsulation to occur directly in a payload region of the ODUk signal, and may increase the capacity of the packet client signal to 10 Gb/s. A capacity of a payload of the ODU2 signal may be 9,995,277 kilobits/second (kbit/s), which is higher than ODUflex(GFP) having eight TSs. Accordingly, even when a size of an average MAC frame is greater than 1,518 bytes, a 10 GBASE-R signal may be transferred without packet loss.

Hereinafter, operations of the relay apparatus 530 will be provided.

According to the conventional method, when a signal is input from the transceiving apparatus, an OTUk overhead (k=2) may be removed from the signal in the OTUk block, and an ODUk (k=2) signal may be obtained by de-mapping an OTUk signal (k=2) in the OTUk/ODUk block. An ODUk overhead (k=2) may be removed from the ODUk signal in the ODUkP block, and an ODUflex signal may be obtained by de-mapping the ODUk signal. A switching function may be performed with respect to the ODUflex signal in the ODU block and may be transmitted to the transceiving apparatus through a reverse operation.

Conversely, according to the exemplary embodiments, when a signal is input from the transceiving apparatus, an OUT overhead (k=2) may be removed from the signal in the OTUk block, and an ODUk signal (k=2) may be obtained by de-mapping an OTUk signal (k=2) in the OTUk/ODUk block. The ODUk signal may be input directly to the ODU block, a switching function may be performed with respect to the ODUk signal, and the ODUk signal may be transmitted through a reverse operation.

A packet transmitting method in the optical transport network will be described with reference to drawings.

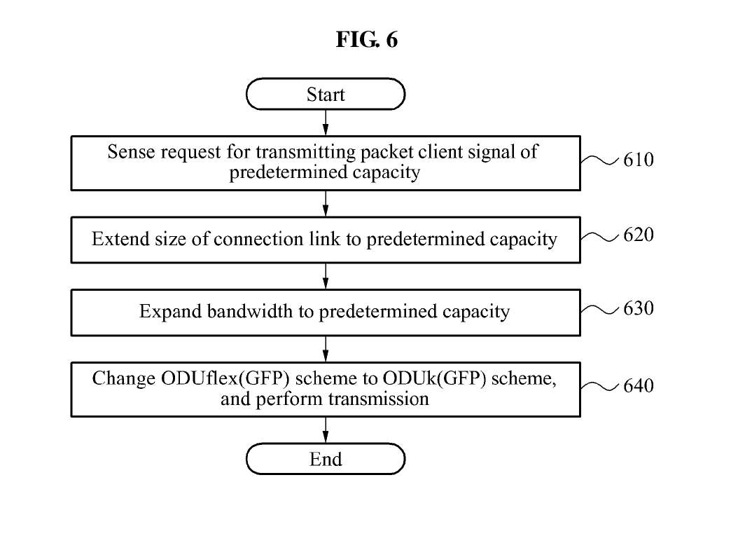

FIG. 6 illustrates a transmission process performed when a capacity of a packet client signal increases to be equivalent to a predetermined capacity in an optical transport network according to an embodiment of the present invention.

Referring to FIG. 6, when a request for transmitting a packet client signal of a predetermined capacity is sensed in operation 610, while transmission is being operated based on an ODUflex(GFP) scheme, a size of a connection link among a transmitting apparatus, a relay apparatus, and a reception apparatus may be extended in operation 620. In this example, in operation 620, using an LCOR bit, included in a control overhead, corresponding to information indicating a change in a bandwidth, the extension of the connection link among the transmitting apparatus, the relay apparatus, and the receiving apparatus may be requested, and the transmitting apparatus, the relay apparatus, and the receiving apparatus may be informed that the connection link is extended.

When the size of the connection link is extended, a bandwidth among the transmitting apparatus, a relay apparatus, and a receiving apparatus may be expanded to a predetermined capacity in operation 630. In this example, using a BWOR bit, included in the control overhead, corresponding to information indicating a change in a bandwidth, the expansion of the bandwidth among the transmitting apparatus, the relay apparatus, and the receiving apparatus may be requested, and the transmitting apparatus, the relay apparatus, and the receiving apparatus may be informed that the bandwidth is expanded.

When the bandwidth is expanded, a transmission scheme for a packet client signal may be changed from the ODUflex(GFP) scheme to an ODUk(GFP) scheme in operation 640.

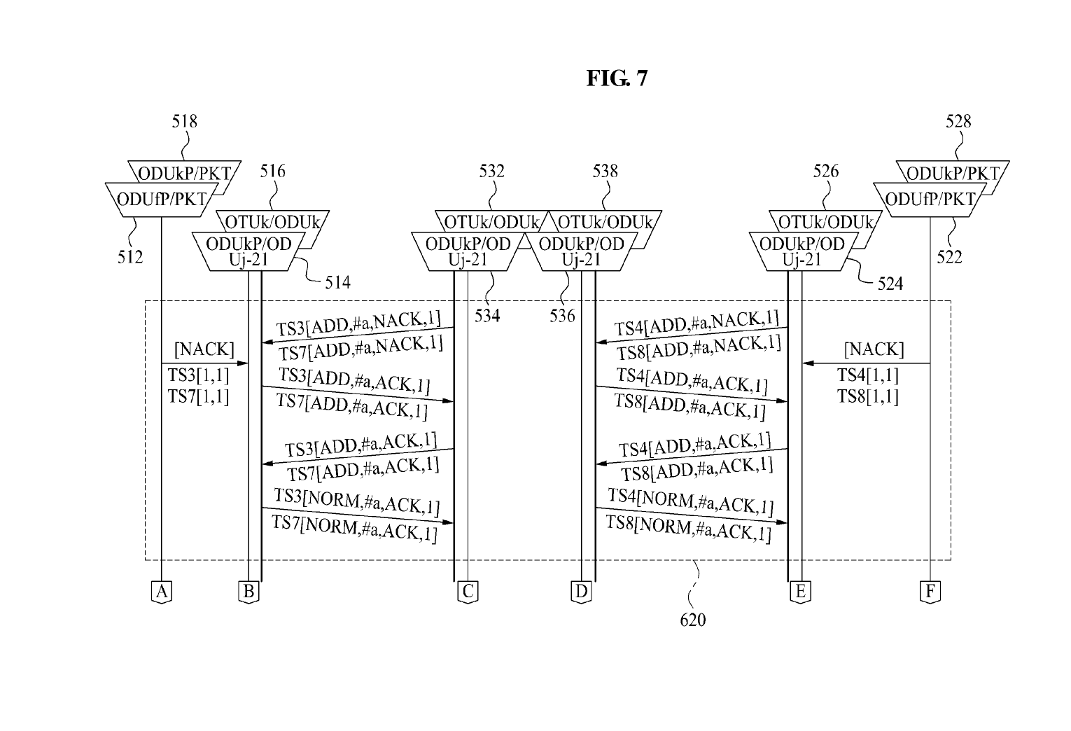

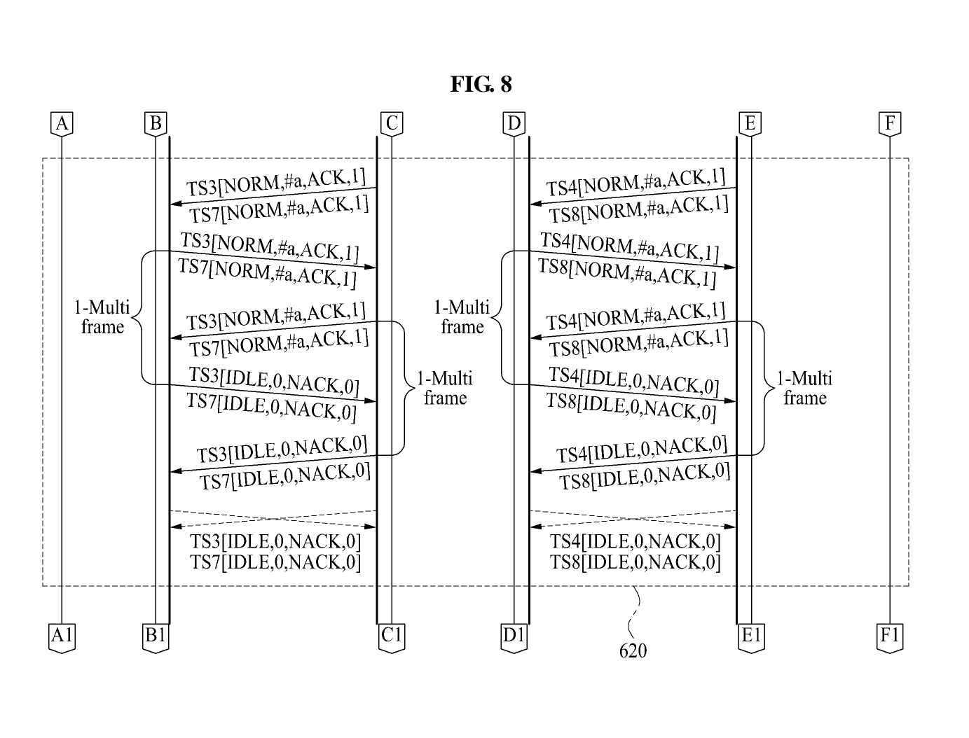

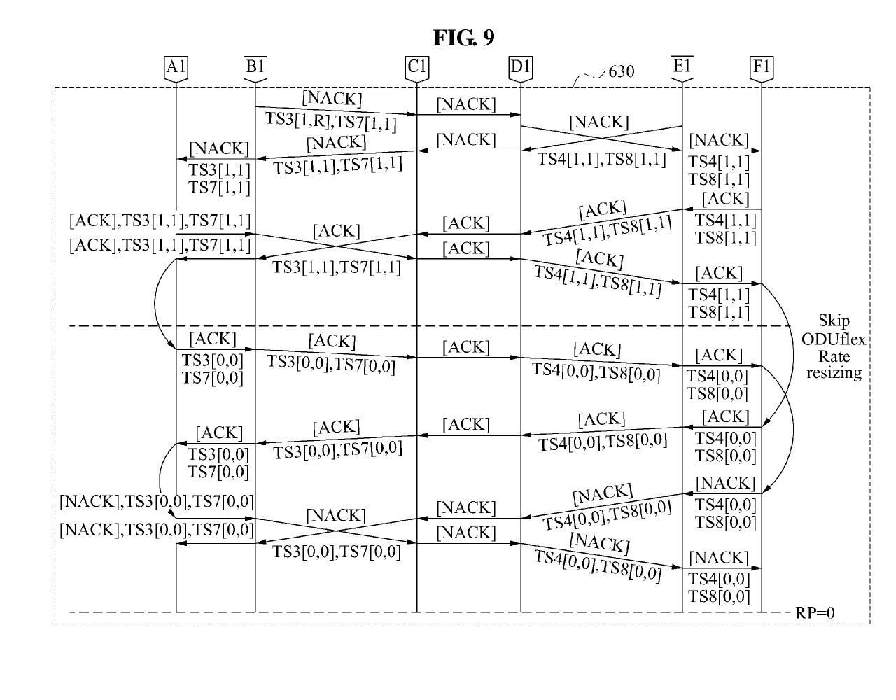

FIGS. 7 through 9 illustrate a flow of a message when a capacity of a packet client signal increases to be equivalent to a predetermined capacity in an optical transport network according to an embodiment of the present invention.

Referring to FIGS. 7 through 9, examples of a message received and transmitted among a transmitting apparatus, a relay apparatus, and a receiving apparatus in operations 620 and 630 of FIG. 6, are provided. Here, operations 620 and 630 may also be referred to as a link connection resizing protocol 620 and a bandwidth resizing protocol 630, respectively. In particular, each node in the optical transport network may perform data transmission and reception through an ODUflex(GFP) having six TSs in an operational state prior to an operational state of FIG. 7. In this example, an operation when a capacity transmitted and received among nodes is increased to adopt a 10 GBASE-R signal, will be provided.

When an add signal is received from an NMS, all nodes may start the link connection resizing protocol 620 and the bandwidth resizing protocol 630. According to the link connection resizing protocol 620, each node may set an RP value to “1”, may set a “[CTRL, TPID, TSGS, LCOR] signal” to be “[ADD, #a, NACK, 1]” for each desire TS to be increased, for example, TS3 and TS7 between a node B and a node C, TS4 and TS8 between a node D and a node E, and may transmit “[ADD, #a, NACK, 1]” to a corresponding adjacent node. In this example, an ODUfP/PKT block, for example, the ODUfP/PKT blocks 512 and 522, may set an LCOR bit to “1” and may set a BWOR bit to “1”, so as to prevent packet loss that may occur when a link of 10 Gb/s is operated using an ODUflex(GFP) having eight TSs by increasing the TS slot.

Each node may determine an availability of the link, and may transmit an acknowledge (ACK) signal to a corresponding adjacent node when the availability is determined to be normal.

When the ACK is received, each node may start a link connection resizing process, and may transmit “[NORM, #a, ACK, 1]” during a 1-multi-frame, for each TS, which informs a subsequent multi-frame of a start of the link connection resizing process. In this example, a node that receives an LCOR signal having a value of “1” may prepare to change a mapping scheme so as to enable the packet client signal to be GFP-encapsulated directly in an LO ODU2 payload region, instead of increasing a TS of the subsequent multi-frame.

The link connection over resizing operation may be completed within the 1-multi frame, and each node may output, to a corresponding adjacent node, “[IDLE, 0, NACK, 0]” for each TS. In this example, the mapping scheme for the packet client signal is changed from the ODUflex(GFP) to the LO ODU2(GFP) and thus, “[NORM, #a, ACK, 1]” and “[IDLE, 0, NACK, 0]” may be inserted to an LO OPU2 overhead, and may be transmitted. Also, the nodes may transmit eight LO ODU2(GFP) frames to be compatible with a conventional ODUflex(GFP). In this example, “[NORM, #a, ACK, 1]” and “[IDLE, 0, NACK, 0]” may be inserted, selectively, to LO ODU2(GFP) frames corresponding to TSs of the ODUflex(GFP), or may be inserted to all of the eight LO ODU2(GFP) frames.

After the link connection over resizing protocol 620 is completed, the nodes may open “[TSCC, BWOR]” and “[NCS]” through a path-through mode, and may transmit the signals to corresponding adjacent nodes. When a TSCC value is “1”, an NCS value is changed to an ACK to report that all link connections are normal.

When an ACK is received in response to the NCS value transmitted as the ACK, an ODUflex rate resizing is started. In this example, when a value of a BWOR bit is “1”, the bandwidth over resizing protocol 630 may be started. In this example, the packet client signal may be mapped to the LO ODU2(GFP), as opposed to the ODUflex(GFP), and thus, the ODUflex rate resizing process may be omitted. That is, when the value of the BWOR bit is “1”, a value of “[TSCC, BWOR]” may be changed to “[0, 0]”, directly, without the ODUflex rate resizing process, and may be output.

When a TSCC value of “0” is received from a far-end node, the NCS value may be changed to a negative acknowledge (NACK) and may transmit the NACK. Here, when the NCS having an NACK value is transmitted or received, end nodes may change a PR value to “0” and may output the changed PR value to adjacent nodes after the bandwidth over resizing process. Each node may inform the NMS that an entire process is completed.

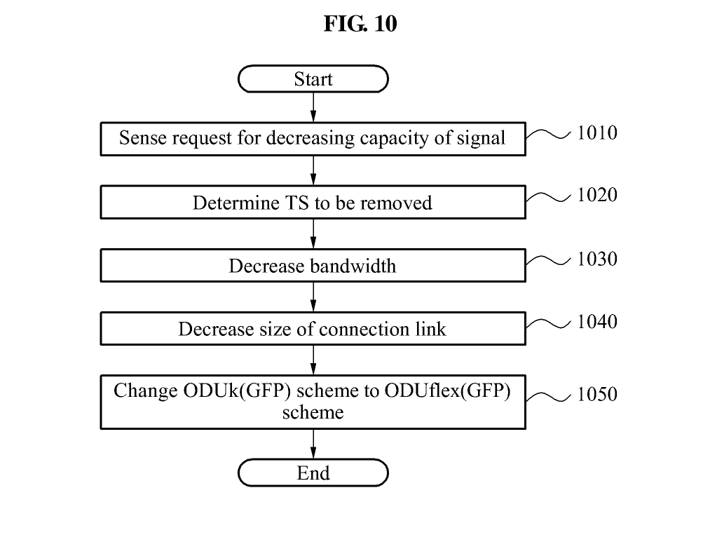

FIG. 10 illustrates a transmission process performed when a capacity of a packet client signal decreases to be less than a predetermined capacity in an optical transport network according to an embodiment of the present invention.

Referring to FIG. 10, when a request for decreasing a capacity of a signal transmitted and received among a transmitting apparatus, a relay apparatus, and a receiving apparatus in operation 1010, while transmission is being operated based on an LO ODU2(GFP) scheme, a TS to be removed to decrease a size of a connection link among the transmitting apparatus, the relay apparatus, and the receiving apparatus in operation 1020 may be determined.

In operation 1030, a bandwidth corresponding to the TS to be removed may be decreased. In this example, using a BWOR bit, included in an OPUk overhead, corresponding to information indicating a change in a bandwidth, decreasing a bandwidth among the transmitting apparatus, the relay apparatus, and the receiving apparatus may be requested, and the transmitting apparatus, the relay apparatus, and the receiving apparatus may be informed that the bandwidth is decreased.

When the bandwidth is decreased, the TS to be removed may be removed so as to decrease the size of the connection link among the transmitting apparatus, the relay apparatus, and the receiving apparatus in operation 1040. In this example, using an LCOR bit, included in an OPUk overhead, corresponding to information indicating a change in a bandwidth, decreasing the connection link among the transmitting apparatus, the relay apparatus, and the receiving apparatus may be requested, and the transmitting apparatus, the relay apparatus, and the receiving apparatus may be informed that the connection link is decreased.

When the size of the connection link is decreased, the transmission scheme for the packet client signal may be changed from the ODUk(GFP) scheme to an ODUflex(GFP) scheme.

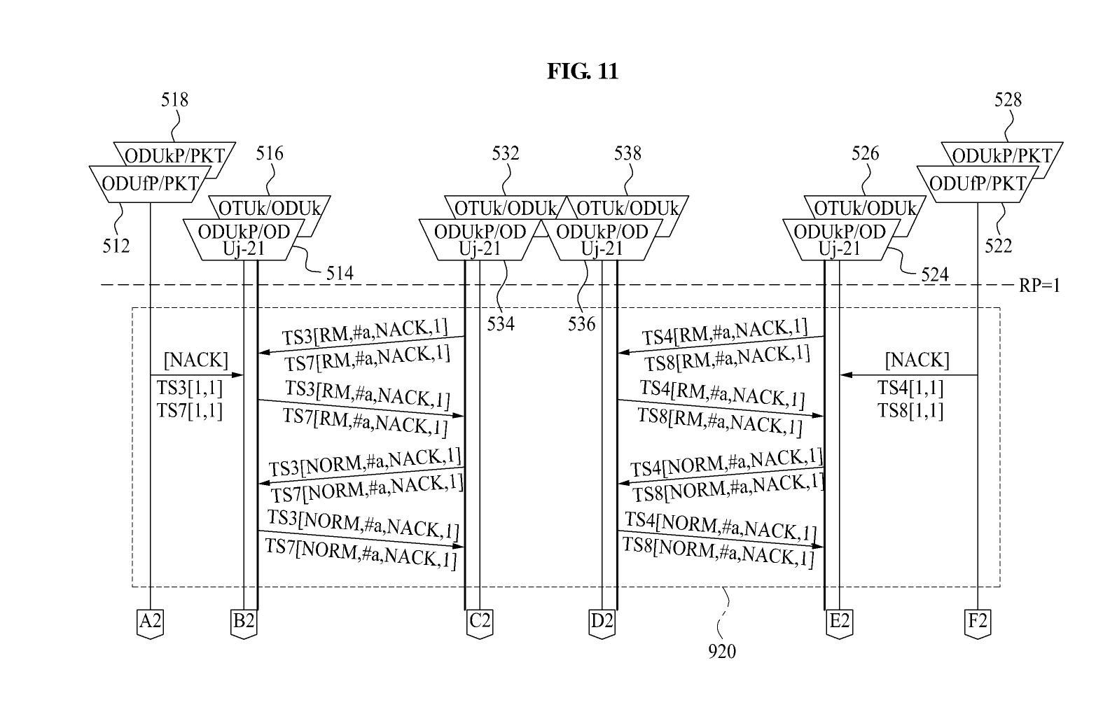

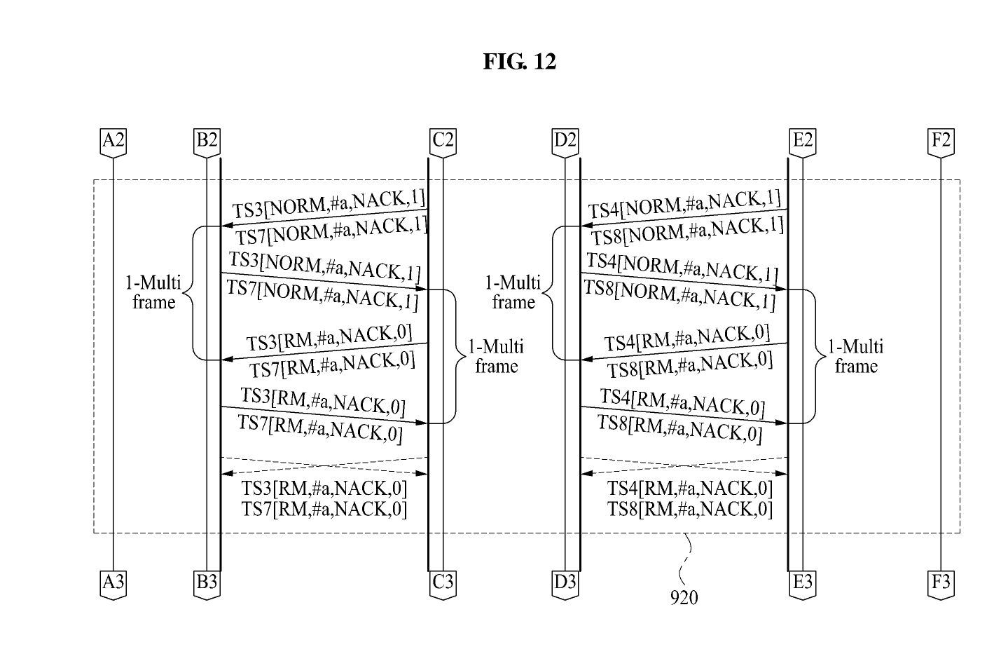

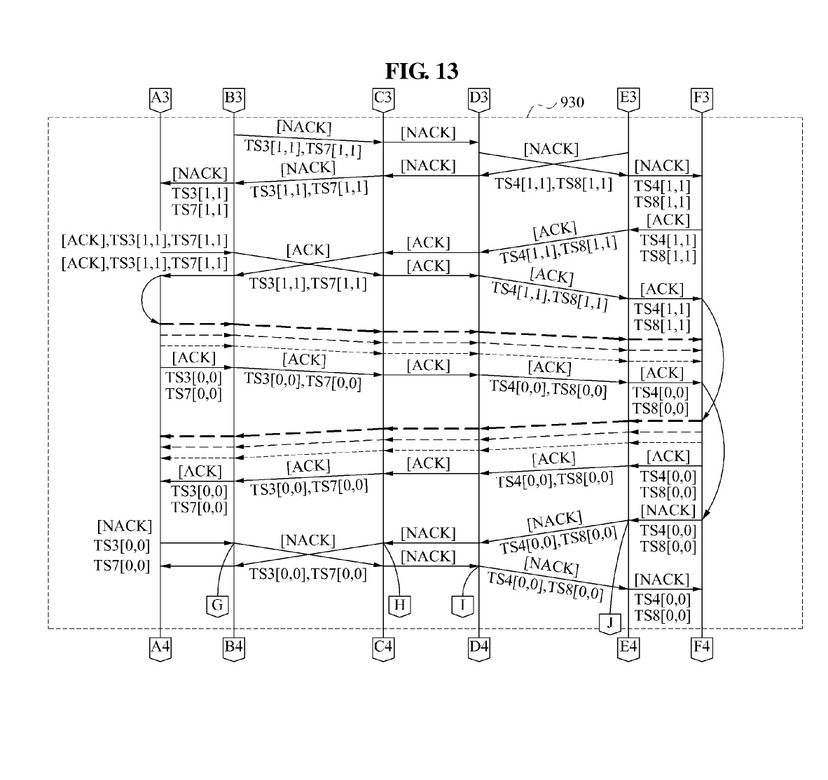

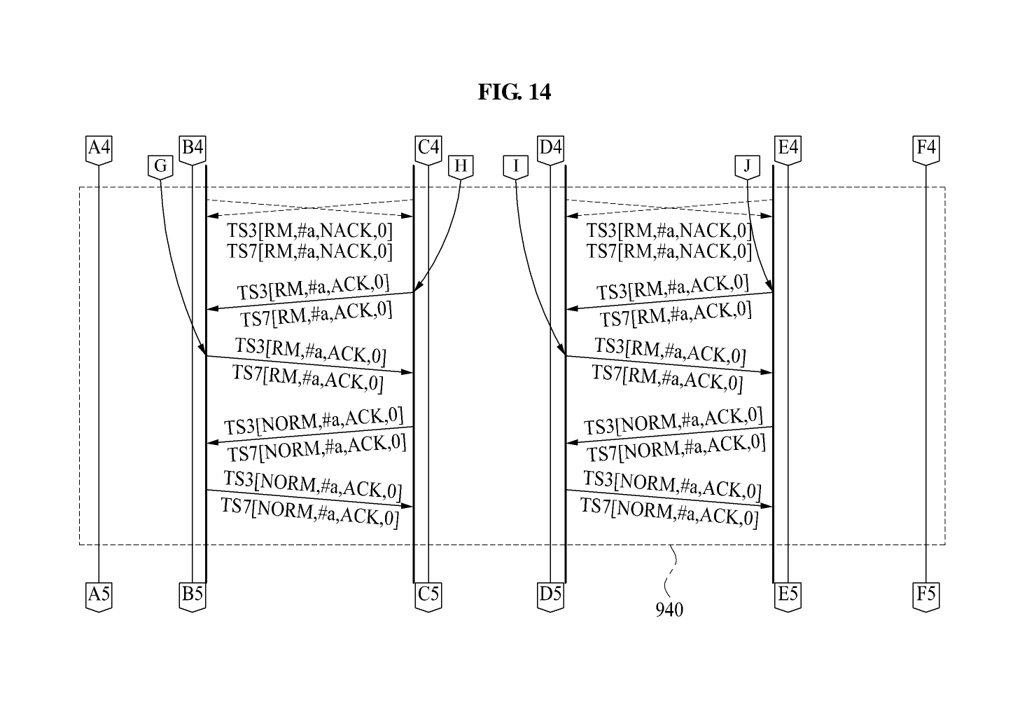

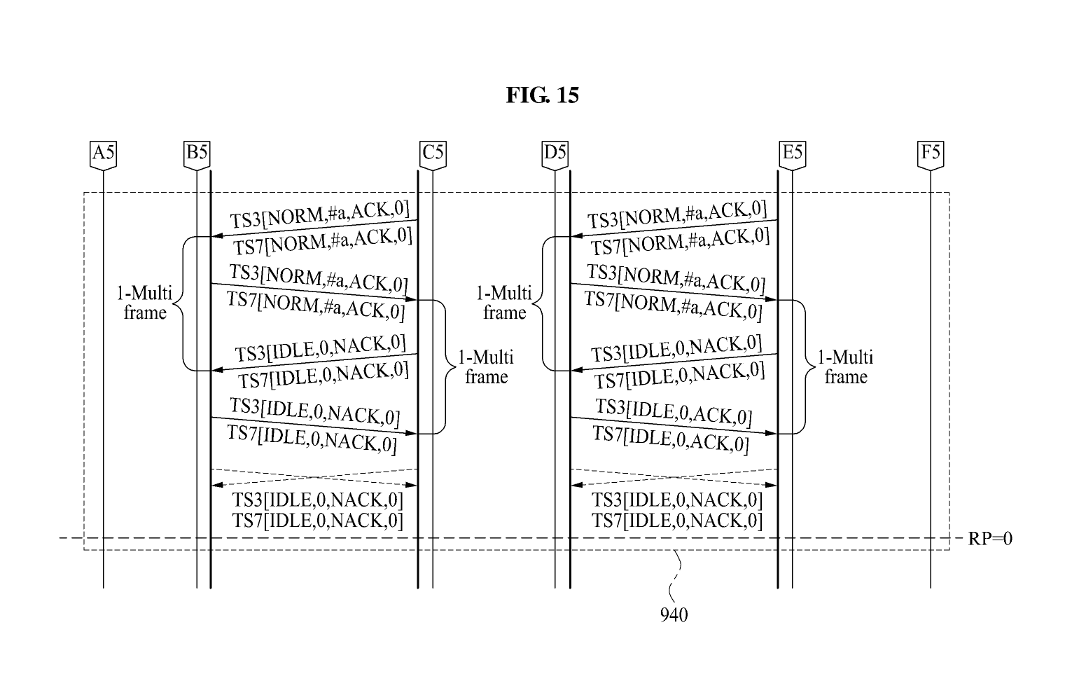

FIGS. 11 through 15 illustrate a flow of a transmission message when a capacity of a packet client signal decreases to be less than a predetermined capacity in an optical transport network according to an embodiment of the present invention.

Referring to FIGS. 11 through 15, examples of a message transmitted and received among a transmitting apparatus, a relay apparatus, and a receiving apparatus in operations 1020, 1030, and 1040 of FIG. 10, are provided.

In particular, each node may perform data transmission and data reception using an LO ODU2(GFP) signal in an operation state prior to an operation state of FIG. 11. In this example, an operation when a capacity among nodes is decreased, will be provided.

When a remove signal is received from an NMS, all nodes may start a link connection resizing protocol and a bandwidth resizing protocol. Each node may set an RP value to “1”, may set a “[CTRL, TPID, TSGS, LCOR] signal” to be “[RM, #a, NACK, LCOR]” for each desire TS to be decreased, for example, TS3 and TS7 between a node B and a node C, TS4 and TS8 between a node D and a node E, and may transmit “[RM, #a, NACK, LCOR]” to a corresponding adjacent node. In this example, an ODUfP/PKT block, for example, the ODUfP/PKT blocks 512 and 522, may set an LCOR bit to “1” and may set a BWOR bit to “1”, so as to change a mapping scheme from the LO ODU2(GFP) to an ODUflex(GFP).

After the remove signals are transmitted and received, each node may start a link connection resizing process, and may transmit “[NORM, #a, NACK, 1]” during a 1-multi-frame corresponding to eight LO ODU2(GFP) frames, for each TS, which informs a subsequent multi-frame of a start of the link connection resizing process. That is, the start of the link connection resizing process may be reported after the eight LO ODU2(GFP) frames. In this example, a node that receives an LCOR signal having a value of “1” may change a mapping scheme so that the packet client signal is mapped to the ODUflex(GFP) signal, as opposed to, an LO ODU2(GFP) signal, in the subsequent multi-frame, that is, after the eight LO ODU2(GFP) frames.

The link connection over resizing operation may be completed within the 1-multi frame, and each node may output, to a corresponding adjacent node, “[RM, #a, NACK, 0]”. In this example, the mapping scheme for the packet client signal is changed from the LO ODU2(GFP) scheme to the ODUflex(GFP) scheme and thus, “[NORM, #a, NACK, 1]” and “[RM, #a, NACK, 0]” may be inserted to an overhead of the TS to be removed, and may be transmitted. When the process described in the foregoing is completed, the link connection over resizing protocol is in an idle state. In this instance, the TS is not yet decreased, and currently, each node recognizes that the TS is to be removed. Accordingly, when the mapping scheme is changed from the LO ODU2(GFP) scheme to the ODUflex(GFP) scheme, the mapping scheme may be changed using an ODUflex(GFP) signal having eight TSs, and stuffing data may be input to the TS to be removed, through a GMP special mode.

When the link connection over resizing protocol is in the idle state, the nodes may open “[TSCC, BWOR]”, “[NCS]” through a path-through mode, and may transmit the signals to corresponding adjacent nodes. When a TSCC value is “1”, an NCS value is changed to an ACK to report that all link connections are normal. Also, based on a BWOR signal having a value of “1”, each node determines that the mapping scheme is changed from the LO ODU2(GFP) scheme to the ODUflex(GFP) scheme.

When an ACK and “1” are received in response to the transmission of the ACK and “1” using the NCS value and the BWOR value, an ODUflex rate resizing is started. When the ODUflex rate resizing is completed, the TSCC value and the BWOR value may be set to “0” and may be outputted.

When a TSCC value of “0” is received from a far-end node, the NCS value may be changed to an NACK and may transmit the NACK. Here, when the NCS having an NACK value is transmitted or received, the link connection over resizing process, which is in the idle state, may be started again.

Subsequently, the nodes may set a GMP to a normal mode, may convert the TSGS to an ACK, and may output the ACK.

When the TSGS having an ACK value is transmitted and received, the nodes may transmit an NORM frame during 1-multi-frame so as to inform a subsequent multi-frame that a TS is removed.

The nodes may change a PR value to “0” and may output the changed PR value to adjacent nodes after the link connection over resizing process is completed. Each node may inform the NMS that an entire process is completed.

The method according to the above-described embodiments of the present invention may be recorded in non-transitory computer readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A transmitting apparatus in an optical transport network, when a request for transmitting a packet client signal of a predetermined capacity is sensed, the apparatus comprising:
a client access unit to selectively output a packet client signal to an ODUk mapping unit or to an ODUflex mapping unit, based on a control overhead;
the ODUk mapping unit to perform mapping of the packet client signal to an ODUk signal, to insert an ODUk overhead to the ODUk signal, and to output the ODUk signal;
the ODUflex mapping unit to perform mapping of the packet client signal to an ODUflex signal, to insert an ODUflex overhead to the ODUflex signal, and to output the ODUflex signal;
an ODUflex multiplexing unit to receive a plurality of ODUflex signals from the ODUflex mapping unit, to multiplex the ODUflex signals, and to output the multiplexed ODUflex signal; and
an OTUk mapping unit to perform mapping of the ODUk signal output from the ODUk mapping unit to an OTUk signal, to insert an OTUk overhead to the OTUk signal, and to output the OTUk signal, or to perform mapping of the multiplexed ODUflex signal output from the ODUflex multiplexing unit to an OTUk signal, to insert an OTUk overhead to the OTUk signal, and to output the OTUk signal.

2. The apparatus of claim 1, wherein the client access unit inserts the control overhead to an OPUk overhead region or to an OPUflex overhead region.

3. The apparatus of claim 2, wherein the control overhead comprises a bandwidth over resizing (BWOR) bit corresponding to information indicating a change in a bandwidth, and a link connection over resizing (LCOR) bit corresponding to information indicating a change in a size of a connection link.

4. The apparatus of claim 1, wherein the ODUk mapping unit performs ODUk(GFP) mapping of the packet client signal to the ODUk signal.

5. The apparatus of claim 1, wherein the ODUflex mapping unit performs ODUflex(GFP) mapping of the packet client signal to the ODUflex signal.

6. A method of transmitting a packet in an optical transport network, the method comprising:
sensing a request for transmitting a packet client signal of a predetermined capacity, during transmission operated based on an ODUflex(GFP) scheme;
extending, to the predetermined capacity, a size of a connection link among a transmitting apparatus, a relay apparatus, and a receiving apparatus when the request is sensed;
expanding, to the predetermined capacity, a bandwidth among the transmitting apparatus, the relay apparatus, and the receiving apparatus when the size of the connection link is extended; and
transmitting the packet client signal by changing a transmission scheme from the ODUflex(GFP) scheme to an ODUk(GFP) scheme, when the bandwidth is expanded.

7. The method of claim 6, wherein the expanding comprises:
requesting expanding of the bandwidth among the transmitting apparatus, the relay apparatus, and the receiving apparatus, and reporting that the bandwidth is expanded, based on a bandwidth over resizing (BWOR) bit corresponding to information indicating a change in a bandwidth included in an OPUk overhead.

8. The method of claim 6, wherein the extending comprises:
requesting extending of the size of the connection link among the transmitting apparatus, the relay apparatus, and the receiving apparatus, and reporting that the connection link is extended, based on a link connection over resizing (LCOR) bit corresponding to information indicating a change in a bandwidth included in an OPUk overhead.

9. A method of transmitting a packet in an optical transport network, the method comprising:
sensing a request for decreasing a capacity of a signal transmitted and received among a transmitting apparatus, a relay apparatus, and a receiving apparatus, during transmission operated based on an ODUk(GFP) scheme;
determining a tributary slot (TS) to be removed to decrease, in response to a request, a size of a connection link among the transmitting apparatus, the relay apparatus, and the receiving apparatus when the request is sensed;
decreasing a bandwidth corresponding to the TS to be removed when the TS to be removed is determined;
decreasing the size of the connection link among the transmitting apparatus, the relay apparatus, and the receiving apparatus by removing the TS to be removed when the bandwidth is decreased; and
transmitting a packet client signal by changing a transmission scheme from the ODUk(GFP) scheme to an ODUflex(GFP) scheme when the size of the connection link is decreased.

10. The method of claim 9, wherein the decreasing of the bandwidth comprises:
requesting decreasing of the bandwidth among the transmitting apparatus, the relay apparatus, and the receiving apparatus, and reporting that the bandwidth is decreased, based on a bandwidth over resizing (BWOR) bit corresponding to information indicating a change in a bandwidth included in an OPUk overhead.

11. The method of claim 9, wherein the decreasing of the size of the connection link comprises:
requesting decreasing of the size of the connection link among the transmitting apparatus, the relay apparatus, and the receiving apparatus, and reporting that the connection link is decreased, based on a link connection over resizing (LCOR) bit corresponding to information indicating a change in a bandwidth included in an OPUk overhead.
